(19) United States
(12) Patent Application Publication
(10) Pub. No.: US 2014/0272107 A1
(43) Pub. Date: Sep. 18, 2014

(54) SUBSTRATE COATING TECHNIQUES

(71) Applicant: ARMOUR KOATINGS LLC, Chicago, IL (US)

(72) Inventors: Ronald Spielman, Chicago, IL (US); Jon A. Neely, Aurora, IL (US); Dennis N. Lyell, Hudson, OH (US)

(21) Appl. No.: 13/841,623

(22) Filed: Mar. 15, 2013

Related U.S. Application Data
(63) Continuation of application No. 13/841,205, filed on Mar. 15, 2013.

(51) Int. Cl. B05C 11/10; B05D 3/12

(52) U.S. Cl. CPC B05C 11/1039; B05D 3/12
USPC 427/8; 118/50; 118/712; 427/350

(57) ABSTRACT

According to certain techniques, a system for coating a substrate includes a preparation component, a coating component, and a curing component. The preparation component includes a plasma applicator that irradiates the substrate with plasma to form a prepared substrate. The coating component coats the prepared substrate with a coating medium to form a coated substrate. The coating component includes a coating head that receives the coating medium from a reservoir and applies the coating medium to the prepared substrate to form the coated substrate. The coating component includes a vacuum that removes an excess amount of the coating medium from the coated substrate. The curing component includes at least one ultraviolet emitter and irradiates the coated substrate with ultraviolet energy to form a cured substrate.

### CROSS REFERENCE TO RELATED APPLICATIONS

This application is a continuation of U.S. patent application Ser. No. 13/841,205 filed on Mar. 15, 2013, the entirety of which is herein incorporated by reference.

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally, this application relates to coating or painting techniques, such as painting of fiberglass window frames. Substrates, such as fiberglass window frames, may be coated with a protective coating. The process of coating may include substrate preparation, coating, and curing.

Some methods of preparation may employ we chemistry or solvents to etch or abrasively after the surface of the substrate. Such methods may be relatively expensive or may involve toxic chemicals.

After preparation, the substrate may be coated with a coating. One technique for coating involves spraying a we coating. Such spraying may waste materials and may include coatings with relatively high and potentially toxic solvent concentrations. While some water-based coatings may be available, the performance of such coatings may not be sufficient for particular applications. Additionally, the problem of waste may still be present with water-based coatings.

After the substrate is coated, the coating may be cured, for example, by heat or by air drying. Such techniques may be relatively energy-intensive or time consuming.

Some existing processes may address some of the challenges posed by each individual stage, but may neglect to address all of such problems and additional problems including speed, complexity, or performance factors.

Additionally, it may be relatively difficult to change colors when running a line. Clean-up, for example, required when a different color is to be used in a coating component, may be time-consuming.

### SUMMARY

According to techniques of the application, a system for coating a substrate may include a preparation component, a coating component, and a curing component. The preparation component may include a plasma applicator that irradiates the substrate with plasma to form a prepared substrate.

The coating component may receive the prepared substrate and may coat it with a coating medium to form a coated substrate. The coating component may include a coating head and a vacuum. The coating head may receive the coating medium from a coating medium reservoir. The coating head may apply the coating medium to the prepared substrate to form the coated substrate. The vacuum may remove an excess amount of the coating medium from the coated substrate. The coating component may include an interchangeable cartridge that may receive excess coating medium and recycle the excess coating medium to the coating head.

The curing component may include at least one ultraviolet emitter and may receive the coated substrate and may irradiate the coated substrate with ultraviolet energy to form a cured substrate. The curing component may also include a first ultraviolet emitter and a second ultraviolet emitter that emit first and second types of ultraviolet energy, respectively. The first type of ultraviolet energy may be more energetic than the second type of ultraviolet energy. The curing component may cure the coated substrate with first type of ultraviolet energy before the second type of ultraviolet energy.

According to techniques of the application, a method for coating a substrate may include preparing the substrate by irradiating the substrate with plasma energy to form a prepared substrate. The prepared substrate may be coated with a coating medium to form a coated substrate. This may take place by first applying the coating medium to the prepared substrate and then removing by vacuum an excess amount of the coating medium from the coated substrate. The coated substrate may be cured with ultraviolet energy to form a cured substrate. In one example, the coated substrate is cured with two different types of ultraviolet energy—a first type and a second type. The first type of ultraviolet energy may be more energetic than the second type of ultraviolet energy. The coated substrate may be cured with the first type of ultraviolet energy before it is cured with the second type of ultraviolet energy.

According to techniques of the application, a system for coating a substrate may include a preparation component, a first coating component, a first curing component, a second coating component, and a second curing component. The preparation component may have a plasma applicator that may irradiate the substrate with plasma to form a prepared substrate. The first coating component may receive the prepared substrate and may coat the prepared substrate with a first coating medium to form a once-coated substrate. The first coating component may have a coating head that may receive the first coating medium from a first coating medium reservoir and may apply the first coating medium to the prepared substrate to form the once-coated substrate. The first coating component may also have a vacuum that removes an excess amount of the first coating medium from the once-coated substrate. The first curing component may include a first type of ultraviolet emitter. The first curing component may receive the once-coated substrate and irradiate it with a first type of ultraviolet energy to form a once-cured substrate.

The second coating component may receive the once-cured substrate and may coat the once-cured substrate with a second coating medium to form a twice-coated substrate. The second coating component may have a coating head that may receive the second coating medium from a second coating medium reservoir and may apply the second coating medium to the once-cured substrate to form the twice-coated substrate. The second coating component may also have a vacuum that removes an excess amount of the second coating medium from the twice-coated substrate. The second curing component may include at least one of a second type of ultraviolet emitter. The second curing component may receive the twice-coated substrate and may irradiate the twice-coated substrate with a second type of ultraviolet energy to form a twice-cured substrate. The second curing component may also include the first type of ultraviolet emitter and may irradiate the twice-coated substrate with the first type of ultraviolet energy (which may be more energetic than the second type of ultraviolet energy).

The first type of ultraviolet energy and the second type of ultraviolet energy may be different. The first type of ultraviolet emitter and the second type of ultraviolet emitter may be different. For example, the first type of ultraviolet emitter may include a Gallium bulb, and the second type of ultraviolet emitter may include a Mercury bulb.

The first coating component may have a first masking die arranged to prevent the first coating medium from being applied to a portion of the prepared substrate. The second coating component may have a second masking die arranged to prevent the second coating medium from being applied to a portion of the once-cured substrate.

According to techniques of the application, a method for coating a substrate may include preparing the substrate by irradiating the substrate with plasma to form a prepared substrate. The prepared substrate may be coated with a first coating medium to form a once-coated substrate. The first coating medium may be applied to the prepared substrate to form the once-coated substrate, and a vacuum may remove an excess amount of the first coating medium from the once-coated substrate. The once-coated substrate may be cured with a first type of ultraviolet energy to form a once-cured substrate.

The once-cured substrate may be coated with a second coating medium to form a twice-coated substrate. The second coating medium may be applied to the once-cured substrate to form the twice-coated substrate, and a vacuum may remove an excess amount of the second coating medium from the twice-coated substrate. The twice-coated substrate may be cured with a second type of ultraviolet energy (which may be different from the first type of ultraviolet energy) to form a twice-cured substrate. The first type of ultraviolet energy may be more energetic than the second type of ultraviolet energy.

While coating the prepared substrate with the first coating medium, a portion of the prepared substrate may be masked to prevent the first coating medium from being applied to the masked portion of the prepared substrate. While coating the once-cured substrate with the second coating medium, a portion of the once-cured substrate may be masked to prevent the second coating medium from being applied to the masked portion of the once-cured substrate.

According to techniques of the application, a system for coating a substrate may include a coating chamber, a first coating medium input port, a first interchangeable cartridge, and a coating head. The coating chamber may accommodate the substrate. The first coating medium input port may receive a first coating medium from a first coating reservoir. The first interchangeable cartridge may retain the first coating medium.

The coating head may include an aperture. The coating head may receive the first coating medium from the first coating medium input port and may receive the first coating medium from the first interchangeable cartridge. The coating head may pass the first coating medium through the aperture towards the coating chamber. The vacuum head may have an aperture and may receive an excess amount of the first coating medium from the coating chamber through the aperture.

The first interchangeable cartridge may receive an excess amount of the first coating medium from the coating chamber, and it may recirculate the first coating medium to the coating head. The first interchangeable cartridge may receive an excess amount of the first coating medium from the vacuum head. The first interchangeable cartridge may have an overflow valve and a sensor that measures a level of the first coating medium. The sensor may cause the overflow valve to open if the level of the first coating medium is greater than a maximum fill level. The first interchangeable cartridge may recirculate the first coating medium to the coating head via the first coating medium input port.

The system may also have a second coating medium input port that may receive a second coating medium from a second coating reservoir. The system may also have a second interchangeable cartridge that may retain the second coating medium. The coating head may selectively receive one of the first coating medium or the second coating medium from a respective one of the first coating medium input port or the second coating medium input port. The coating head may also selectively receive one of the first coating medium or the second coating medium from a respective one of the first interchangeable cartridge or the second interchangeable cartridge. The vacuum head may further receive an excess amount of the first coating medium or an excess amount of the second coating medium from a respective one of the coating reservoir or the second coating reservoir through the aperture. The second interchangeable cartridge may receive an excess amount of the second coating medium from the coating chamber, and it may recirculate the second coating medium to the coating head. The second interchangeable cartridge may also receive an excess amount of the second coating medium from the vacuum head.

The second interchangeable cartridge may have an overflow valve and a sensor. The sensor may measure a level of the second coating medium in the second interchangeable cartridge, and it may cause the overflow valve to open if the level of the second coating medium is greater than a maximum fill level. The second interchangeable cartridge may recirculate the second coating medium to the coating head via the second coating medium input port.

The system may have a flush fluid input port that may receive a flush fluid from a flush fluid reservoir. The system may also have a third interchangeable cartridge that may retain the flush fluid. The coating head may selectively receive one of the first coating medium, the second coating medium, or the flush fluid from a respective one of the first coating medium input port, the second coating medium input port, or the flush fluid input port. The coating head may also selectively receive one of the first coating medium, the second coating medium, or the flush fluid from a respective one of the first interchangeable cartridge, the second interchangeable cartridge, or the third interchangeable cartridge.

The vacuum head may receive an excess amount of the first coating medium, the second coating medium, or the flush fluid from a respective one of the first coating reservoir, the second coating reservoir, or the flush fluid reservoir through the aperture. The third interchangeable cartridge may receive an excess amount of the flush fluid from the coating chamber, and it may recirculate the flush fluid to the coating head. The third interchangeable cartridge may receive an excess amount of the flush fluid from the vacuum head. The third interchangeable cartridge may have an overflow valve and a sensor. The sensor may measure a level of the flush fluid in the third interchangeable cartridge, and it may cause the overflow valve to open if the level of the flush fluid is greater than a maximum fill level. The third interchangeable cartridge may recirculate the flush fluid to the coating head via the flush fluid input port.

According to techniques of the present application, a method for operating a coating component includes connecting a first interchangeable cartridge to a coating chamber drain valve. A first coating medium may be received at a coating head from the first interchangeable cartridge (for example, via a first coating medium input port). A first substrate may be coated in a coating chamber by passing the first coating medium through an aperture in the coating head and into the coating chamber. An excess amount of the first coating medium may be vacuumed through a vacuum head from the first substrate. An excess amount of the first coating medium may be received at the first interchangeable cartridge from the coating chamber via the coating chamber drain valve. The vacuumed first coating medium may be received at the first interchangeable cartridge and from the vacuum head. A level of the first coating medium in the first interchangeable cartridge may be measured with a sensor in the first interchangeable cartridge. If the level of the first coating medium is greater than a maximum fill level, the sensor may cause an overflow valve in the first interchangeable cartridge to open.

The method may include connecting a second interchangeable cartridge to the coating chamber drain valve. A second coating medium may be received at the coating head from a second coating medium input port and from the second interchangeable cartridge. A second substrate may be coated in a coating chamber by passing the second coating medium through the aperture in the coating head and into the coating chamber. An excess amount of the second coating medium from the second substrate may be vacuumed through the vacuum head. An excess amount of the second coating medium from the coating chamber may be received at the second interchangeable cartridge and via the coating chamber drain valve. The vacuumed second coating medium may be received at the second interchangeable cartridge and from the vacuum head.

A level of the second coating medium in the second interchangeable cartridge may be measured with a sensor in the second interchangeable cartridge. If the level of the second coating medium is greater than a maximum fill level, the sensor may cause an overflow valve in the second interchangeable cartridge to open.

A third interchangeable cartridge may be connected to the coating chamber drain valve. A flush fluid from a flush fluid input port and from the third interchangeable cartridge may be received at the coating head. The flush fluid may be passed through the aperture in the coating head and into the coating chamber. An excess amount of the flush fluid from the coating chamber may be vacuumed through the vacuum head. An excess amount of the flush fluid from the coating chamber may be received at the interchangeable cartridge and via the coating chamber drain valve. The vacuumed flush fluid may be received at the third interchangeable cartridge and from the vacuum head.

The level of the flush fluid in the third interchangeable cartridge may be measured with a sensor in the third interchangeable cartridge. If the level of the flush fluid is greater than a maximum fill level, the sensor may cause an overflow valve in the third interchangeable cartridge to open. The flush fluid from the third interchangeable cartridge may be received at the coating head via the third coating medium input port.

### BRIEF DESCRIPTION OF SEVERAL VIEWS OF THE DRAWINGS

FIG. 1 illustrates a side elevation view of a system for coating a substrate, according to techniques of the present application.

FIGS. 2A and 2B illustrate schematic representations of coating components and associated components, according to techniques of the present application.

FIG. 3 illustrates a schematic representation of a coating component and associated components, according to techniques of the present application.

FIGS. 4A and 4B illustrate a schematic representation of a coating component and associated components, according to techniques of the present application.

FIGS. 5A and 5B illustrate a substrate and complementary dies, according to techniques of the present application.

FIG. 6 illustrates a flowchart of a method for coating a substrate, according to techniques of the present application.

FIG. 7 illustrates a flowchart of a method for coating a substrate, according to techniques of the present application.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

FIG. 1 illustrates a side elevation view of a system 100 for coating a substrate 10 according to techniques of the present application. The system 100 may include a first conveyor 110, a preparation component 120, a second conveyor 130, a first coating component 140, a first curing component 150, a second coating component 160, a third conveyor 170, a second curing component 180, and a fourth conveyor 190.

A substrate 10 may be made from fiberglass or other materials, such as plastic, aluminum, or vinyl. The substrate 10 may be used for applications such as window or door frames. The substrate 10 may be used for double-hung window frames. The substrate 10 may be an elongated piece, such as a 14′ or 21′ piece.

The first conveyor 110 may include a motor in communication with wheels or a belt to drive the substrate 10 through the system 100. The first conveyor 110 may also include rollers and/or guides to align the substrate 10. The first conveyor 110 may drive the substrate 10 through the system 100, for example, at a rate of 30′-60′ feet per minute. Once a first substrate 10 has passed through the first conveyor 110, a subsequent substrate 10 may be fed into the first conveyor 110. The first conveyor 110 may drive the subsequent substrate 10, which will continue pushing the first substrate 10 through the system 100.

After the first conveyor 110, the substrate 10 may enter the preparation component 120. The preparation component 120 may prepare a surface of the substrate 10 such that the substrate 10 more readily accepts a coating applied in the subsequent first coating component 140.

The preparation component 120 may irradiate the substrate with plasma. The plasma may be applied by one or more plasma applicators. For example, there may be less or more applicators depending on the complexity of the surface of the substrate. The plasma may be atmospheric pressure plasma. The plasma may alter the surface tension of the substrate 10 to prepare the substrate for subsequent coating. The plasma may also clean or decontaminate the surface of the substrate 10. The plasma applicators may be jets. Such jets may be adjustable in three dimensions. The jets may be mounted on 270° circle-segment guides. Scales may be mounted on the guides to allow for reproducible jet adjustment of the treatment distance to the surface of the substrate 10.

Following the preparation component 120, the substrate 10 may enter a second conveyor 130. The second conveyor 130 may be similar to the first conveyor 110. The second conveyor 130 may not have a motor, but may have guides and/or rollers to align the prepared substrate 10 before it enters the first coating component 140.

Following the second conveyor 130, the substrate 10 may enter the first coating component 140. The structure and function of the first coating component 140 is described in greater detail below in conjunction with the description of FIGS. 2-5B.

After the substrate 10 has been coated at the first coating component 140, the substrate 10 may enter the first curing component 150. The first curing component 150 may include multiple ultraviolet (“UV”) emitters arranged in variously adjustable configurations. The first curing component 150 may include one or more Gallium bulbs that may operate at 600 Watts/inch. The UV emitters may irradiate the substrate 10 (and the coating thereon) with ultraviolet energy to cure or stabilize the coating. The first curing component 150 may be substantially light-tight. The first curing component 150 may be a deep curing component, in that it may cure the substrate 10 at a relatively deep level. The first curing component 150 may cure the substrate 10 at a level below the coating applied at the first coating component 140 (for example, curing 3 mils deep when the coating is 1.5 mils deep). Curing the substrate 10 (or the coating thereon) may improve the adhesion of the coating to the substrate 10. The coating (or the substrate 10 below the coating) may be cured such that it is substantially stable and will not bleed onto uncoated portions of the substrate 10.

After being cured by the first curing component 150, the substrate 10 may enter the second coating component 160. The second coating component 160 may be similar to the first coating component 140, which is described in greater detail below in conjunction with the description of FIGS. 2-5B.

After leaving the second curing component 160, the substrate 10 may be loaded on the third conveyor 170. The third conveyor 170 may be similar to the second conveyor 130. The third conveyor 170 may not have a motor, but may have guides and/or rollers to align the substrate 10 before it enters the second curing component 180.

After the third conveyor 170, the substrate 10 may enter the second curing component 180. The second curing component 180 may be similar to the first curing component 150 (for example, it may be substantially light-tight and may have multiple UV emitters arranged in variously adjustable configurations that irradiate the substrate 10 with UV energy). The second curing component 180 may include two stages—a deep curing stage and a surface curing stage. The deep curing stage may be performed before the surface curing stage. The deep curing stage may result in curing of the coating similar to that performed by the first curing component 150. To this end, the deep curing stage may employ one or more Gallium bulbs that may operate at 600 Watts/inch.

The surface curing stage may cure the coating at a shallower level by using less energetic UV energy. The surface curing stage may employ Mercury bulbs that may operate at 600 Watts/inch. The surface curing stage may cure the coating on the substrate 10 so it is substantially stable.

After the second curing component 180, the substrate 10 may be loaded on the fourth conveyor 190. The fourth conveyor 190 may be similar to the second conveyor 130. The fourth conveyor 190 may not have a motor. After the fourth conveyor 190, the process may be completed and a user or machine may remove the coated and cured substrate 10.

As depicted in FIG. 1 and described above, the system 100 may have two coating components 140, 160 and two curing components 150, 180. It may also be possible to have only one coating component and only one curing component. In such a case, the curing component may be similar to either curing component 150 (which may perform deep curing) or curing component 180 (which may perform deep curing and surface curing).

FIG. 6 illustrates a flowchart 600 of a method for coating a substrate (for example, substrate 10), according to techniques of the present application. The process may be performed by a system such as system 100 that has only one coating component and one curing component. At step 610, the substrate may be irradiated with plasma to form a prepared substrate. Next, optionally, a portion of the prepared substrate may be masked with a masking die at step 620. At step 630, a coating medium may be applied to the prepared substrate (whether masked or not) to form a coated substrate. At step 640, excess coating medium may be removed with a vacuum from the coated substrate. At step 650, the coated substrate may be cured with ultraviolet energy to form a cured substrate.

FIG. 7 illustrates a flowchart 700 of a method for coating a substrate (for example, substrate 10), according to techniques of the present application. The process may be performed by a system such as system 100. At step 710, the substrate may be irradiated with plasma to form a prepared substrate. Next, optionally, a portion of the prepared substrate may be masked with a masking die (included in the first coating component) at step 720. An example of a masking die 11 is shown in FIG. 5A. At step 730, a first coating medium may be applied to the prepared substrate (whether masked or not) to form a once-coated substrate. If employed, the masking die may prevent the first coating medium from being applied to a portion of the prepared substrate. At step 740, excess first coating medium may be removed with a vacuum from the once-coated substrate.

At step 750, the once-coated substrate may be cured with ultraviolet energy to form a once-cured substrate. Next, optionally, a portion of the once-cured substrate may be masked with a masking die at step 760. The masking die (included in the second coating component) may be complementary to that used in step 720. An example of a complementary masking die 11 is shown in FIG. 5B. At step 770, a second coating medium may be applied to the once-cured substrate (whether masked or not) to form a twice-coated substrate. If employed, the masking die may prevent the second coating medium from being applied to a portion of the prepared substrate. At step 780, excess second coating medium may be removed with a vacuum from the twice-coated substrate. At step 790, the twice-coated substrate may be cured with ultraviolet energy to form a twice-cured substrate.

FIG. 2A illustrates a schematic representation of the first coating component 140 and associated components, according to techniques of the present application. The first coating component 140 is in fluid communication with coating reservoir A 101 and coating reservoir B 102.

The reservoirs 101, 102 may contain a coating medium, such as a high performance UV cure single component water base paint. The coating medium in the reservoirs 101, 102 may be different colors.

The coating medium may be supplied from the reservoirs 101, 102 to the first coating component 140. Excess coating medium may be circulated from the first coating component 140 back to either of reservoirs 101, 102. Only one reservoir 101, 102 may supply coating medium to the first coating component 140 at a given time. The coating medium may be pressurized in the system via a blower (not shown).

The first coating component 140 may also be in fluid communication with a flush reservoir 105 and a waste reservoir 106. The flush reservoir 105 may contain a flush fluid, such as soap and water. The flush fluid may flush out coating medium from the first coating component 140. After passing through the first coating component 140, the flush fluid may then become waste and may be transferred to the waste reservoir 106.

FIG. 2B illustrates a schematic representation of the second coating component 160 and associated components, according to techniques of the present application. The first coating component 160 is in fluid communication with coating reservoir C 103 and coating reservoir D 104. The reservoirs 103, 104 may contain a coating mediums similar to those contained in reservoirs 101, 102. The coating medium in the reservoirs 103, 104 may be different colors. Between reservoirs 101-104, four different colors may be contained.

The coating medium may be supplied from the reservoirs 103, 104 to the second coating component 160. Excess coating medium may be circulated from the second coating component 160 back to either of reservoirs 103, 104. Only one reservoir 103, 104 may supply coating medium to the second coating component 160 at a given time. The coating medium may be pressurized in the system via a blower (not shown).

The second coating component 160 may also be in fluid communication with a flush reservoir 105 and a waste reservoir 106. The flush reservoir 105 may contain a flush fluid. The flush fluid may flush out coating medium from the second coating component 160. After passing through the second coating component 160, the flush fluid may then become waste and may be transferred to the waste reservoir 106.

FIG. 3 illustrates a schematic representation of the first coating component 140 and an associated reservoir 101, according to techniques of the present application. A similar schematic representation, though not depicted, may be applicable to the first coating component 140 and reservoir 102. The system may selectively connect coating reservoir 101 or 102 to the first coating component 140. A similar schematic representation, though not depicted, may be applicable to the second coating component 160 and reservoirs 103 or 104 (which may be selectively connected to the second component 160).

The first coating component 140 may include a coating head 141, a vacuum head 142, and a cartridge 143. Coating medium from the reservoir 101 may flow to the coating head 102. The coating head 102 may include one or more apertures through which coating medium can flow. The coating head 102 may pass coating medium towards the substrate 10. Excess coating medium that does not adhere to the substrate 10 may flow into the cartridge 143.

The vacuum head 142 may include one or more apertures through which coating medium can flow. Vacuum pressure may draw a certain amount of coating medium off of the substrate 10 and through the apertures in the vacuum head 142. The amount of coating medium drawn off the substrate 10 may depend on the intensity of the vacuum pressure. The vacuumed coating medium may then flow to the cartridge 143. The cartridge 143 may recirculate coating medium to the coating head 141. If there is an overflow of coating medium in the cartridge 143, it may be circulated back to the coating reservoir 101. The cartridge 143 may be interchangeable with other cartridges 143.

FIGS. 4A and 4B illustrate a schematic representation of the first coating component 140 and associated components, according to techniques of the present application. Turning to FIG. 4A, the coating reservoir A 101 may be connected to a first input port 144A in the first coating component 140. The flush reservoir 102 may be connected to a second input port 144B in the first coating component 140. The coating reservoir B may be connected to a third input port 144C in the first coating component 140. The first coating component 140 may selectively choose and switch one of the three input ports 144A-C to receive a respective coating medium or flush fluid.

Three cartridges 143A-C may be interchangeable and laterally moveable. The cartridges 143A-C may be selectively placed so as to be at least temporarily operable with the first coating component 140. The cartridges 143A-C may be selectively placed so as to receive a coating or flush fluid via a coating chamber drain valve 146. The cartridges 143A-C may be on a conveyor belt (for example, a bi-directional conveyor belt) that provides for selective placement. Each of the cartridges 143A-C may have a valve 147 (for example, a level-indicated inverter valve) that is in fluid communication with a respective input port 144A-C via piping. Each of the cartridges 143A-C may have an overflow valve 145 that is in fluid communication with a respective reservoir 101, 102, or 106 via piping.

The second coating component 160 may be similar to the first coating component 140, but may be connected to different coating reservoirs. For example, while cartridge 143A and the first input port may be in fluid communication with coating reservoir A 101 in the first coating component 140, a similar cartridge and first input port in the second coating component 160 may be in fluid communication with coating reservoir C 103. As another example, while cartridge 143C and the third input port may be in fluid communication with coating reservoir B 102 in the first coating component 140, a similar cartridge and third input port in the second coating component 160 may be in fluid communication with coating reservoir D 104.

Turning to FIG. 4B, the substrate 10 may be in a coating chamber. The substrate 10 may be coated from one or more directions with a coating medium (for this example, the coating medium held in coating reservoir A 101). Excess coating medium may collect at the bottom of the coating chamber and flow through the coating chamber drain valve 146, and into a hollow interior area of a cartridge (for this example, cartridge 143A). Although not shown, excess coating medium may also be vacuumed off of the substrate 10 and also circulated into the cartridge 143A.

The cartridge 143A may be able to contain a certain amount of coating medium. Once a maximum fill level is reached, a sensor 148 may detect this condition and cause the overflow valve 145 to open to prevent the coating medium from exceeding the maximum fill level. The excess coating may then flow to coating reservoir A 101. The cartridge 143A may provide the coating medium to an input port (for this example, the first input port 144A) via valve 147 (for example, a level-indicated inverter valve). The first input port 144A may also receive coating medium from the coating reservoir A 101.

The first coating component 140 may also have a vacuum input 149 that may be connected to a vacuum source. The vacuum that is fed through the input 149 maintains and allows the first coating component 140 to function as described herein.

The following is an illustrative example of how substrates may be coated with a coating system, such as system 100. An operator loads a first fiberglass substrate on a conveyor belt. The conveyor belt drives the first substrate through the coating system. The first substrate enters a preparation component, in which the first substrate is irradiated with plasma energy. The plasma energy alters the surface of the first substrate to improve adhesion of coating medium. The plasma energy also cleans the first substrate.

Next, the first substrate is loaded on a conveyor. The conveyor includes guides that align the first substrate to substantially precisely enter the first coating component. A masking die is located in the first coating component so that only a portion of the first substrate will be coated.

The first coating component has three cartridges and is connected to three reservoirs via three input ports. The first cartridge and the first reservoir are connected to the first input port and contain blue paint. The second cartridge and the second reservoir are connected to the second input port and contain flush fluid. The third cartridge and the third reservoir are connected to the third input port and contain green paint.

Initially, the first cartridge with blue paint is loaded in the first coating component. The first input port of the first coating component is selected, and the blue paint flows from the first reservoir and the first cartridge to the first input port. The blue paint then flows to the coating head and exits into the coating chamber. Some of the blue paint in the unmasked portion of the first substrate adheres to the first substrate. The non-adhering blue paint then flows through the drain valve and into the first cartridge. Some of the blue paint that adheres to the first substrate is vacuumed off through a vacuum head and it is delivered to the first cartridge. As the blue paint level rises in the first cartridge, a sensor recognizes that a maximum fill level has been reached. Responsively, the overflow valve is opened and some of the blue paint flows from the first cartridge back to the first reservoir.

After being coated to a depth of 1.5 mils, the first substrate enters the first curing component. In the first curing component, the first substrate is irradiated with ultraviolet energy from a Gallium bulb operating at 600 Watts/inch. The ultraviolet energy from the Gallium bulb is relatively energetic and penetrates through the 1.5 mil coating to the underlying fiberglass. The underlying fiberglass is cured and this causes the blue paint to stabilize—for example, causes the blue paint to stop from bleeding.

Next, the first substrate enters the second coating component. A masking die is located in the second coating component so that only a portion of the first substrate will be coated. The masking die in the second coating component is complementary to the masking die in the first coating component. The masking die in the second coating component masks the previously coated portion of the first substrate. The second coating component has three cartridges and is connected to three reservoirs via three input ports. The first cartridge and the first reservoir are connected to the first input port and contain orange paint. The second cartridge and the second reservoir are connected to the second input port and contain flush fluid. The third cartridge and the third reservoir are connected to the third input port and contain yellow paint.

Initially, the first cartridge with orange paint is loaded in the second coating component. The first input port of the second coating component is selected, and the orange paint flows from the first reservoir and the first cartridge to the first input port. The orange paint then flows to the coating head and exits into the coating chamber. Some of the orange paint in the unmasked portion of the first substrate adheres to the first substrate. The non-adhering orange paint then flows through the drain valve and into the first cartridge. Some of the orange paint that adheres to the first substrate is vacuumed off through a vacuum head and it is delivered to the first cartridge. As the orange paint level rises in the first cartridge, a sensor recognizes that a maximum fill level has been reached. Responsively, the overflow valve is opened and some of the orange paint flows from the first cartridge back to the first reservoir.

After being coated in the second coating chamber to a depth of 1.5 mils, the substrate is blue and orange and it travels into the second curing component. In the second curing component, the first substrate is irradiated with ultraviolet energy from a Gallium bulb operating at 600 Watts/inch. The ultraviolet energy from the Gallium bulb is relatively energetic and penetrates through the 1.5 mil coating to the underlying fiberglass. The underlying fiberglass is cured and this causes the orange paint to stabilize—for example, causes the orange paint to stop from bleeding. The first substrate is then irradiated with ultraviolet energy from a Mercury bulb operating at 600 Watts/inch. The ultraviolet energy from the Mercury bulb is relatively less energetic than that of the Gallium bulb. The ultraviolet energy cures the paint at a shallower level than the Gallium-stage curing. After being cured, the first substrate is blue and orange and it is unloaded from the system and into temporary storage.

Next, the first coating component loads the second cartridge with the flush fluid. The second cartridge is automatically loaded by a conveyor belt. The second input port of the first coating component is selected, and the flush fluid flows from the second reservoir and the second cartridge to the second input port. The flush fluid then flows to the coating head and exits into the coating chamber. The flush fluid then flows through the drain valve and into the second cartridge. Some of the flush fluid vacuumed through the vacuum head and it is delivered to the second cartridge. As the flush fluid rises in the second cartridge, a sensor recognizes that a maximum fill level has been reached. Responsively, the overflow valve is opened and some of the flush fluid from the second cartridge to a waste reservoir. After being flushed with the flush fluid for a period of time, the blue paint has been substantially cleansed from the first coating component. Then the third cartridge containing the green paint is loaded into the first coating component.

Next, the second coating component loads the second cartridge with the flush fluid. The second cartridge is automatically loaded by a conveyor belt. The second input port of the first coating component is selected, and the flush fluid flows from the second reservoir and the second cartridge to the second input port. The flush fluid then flows to the coating head and exits into the coating chamber. The flush fluid then flows through the drain valve and into the second cartridge. Some of the flush fluid vacuumed through the vacuum head and it is delivered to the second cartridge. As the flush fluid rises in the second cartridge, a sensor recognizes that a maximum fill level has been reached. Responsively, the overflow valve is opened and some of the flush fluid from the second cartridge to a waste reservoir. After being flushed with the flush fluid for a period of time, the orange paint has been substantially cleansed from the second coating component. Then the third cartridge containing the yellow paint is loaded into the first coating component.

Once the system is set up with the green and yellow paints, the aforementioned process is repeated for a second substrate, and a green and yellow substrate is created.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A system for coating a substrate, wherein the system comprises:
a coating chamber configured to accommodate the substrate;
a first coating medium input port configured to receive a first coating medium from a first coating reservoir;
a first interchangeable cartridge configured to retain the first coating medium;
a coating head including an aperture, wherein the coating head is configured to:
receive the first coating medium from the first coating medium input port,
receive the first coating medium from the first interchangeable cartridge, and
pass the first coating medium through the aperture towards the coating chamber;
a vacuum head including an aperture and configured to receive an excess amount of the first coating medium from the coating chamber through the aperture; and
wherein the first interchangeable cartridge is configured to:
receive an excess amount of the first coating medium from the coating chamber, and
recirculate the first coating medium to the coating head.

2. The system of claim 1, wherein the first interchangeable cartridge is configured to receive an excess amount of the first coating medium from the vacuum head.

3. The system of claim 1, wherein the first interchangeable cartridge further comprises:
an overflow valve; and
a sensor configured to:
measure a level of the first coating medium in the first interchangeable cartridge, and
cause the overflow valve to open if the level of the first coating medium is greater than a maximum fill level.

4. The system of claim 1, wherein the first interchangeable cartridge is configured to recirculate the first coating medium to the coating head via the first coating medium input port.

5. The system of claim 1, further comprising:
a second coating medium input port configured to receive a second coating medium from a second coating reservoir;
a second interchangeable cartridge configured to retain the second coating medium;
wherein the coating head is further configured to:
selectively receive one of the first coating medium or the second coating medium from a respective one of the first coating medium input port or the second coating medium input port, and
selectively receive one of the first coating medium or the second coating medium from a respective one of the first interchangeable cartridge or the second interchangeable cartridge;
wherein the vacuum head is further configured to receive an excess amount of the first coating medium or an excess amount of the second coating medium from a respective one of the coating reservoir or the second coating reservoir through the aperture; and
wherein the second interchangeable cartridge is configured to:
receive an excess amount of the second coating medium from the coating chamber, and
recirculate the second coating medium to the coating head.

6. The system of claim 5, wherein the second interchangeable cartridge is configured to receive an excess amount of the second coating medium from the vacuum head.

7. The system of claim 5, wherein the second interchangeable cartridge further comprises:
an overflow valve; and
a sensor configured to:
measure a level of the second coating medium in the second interchangeable cartridge, and
cause the overflow valve to open if the level of the second coating medium is greater than a maximum fill level.

8. The system of claim 5, wherein the second interchangeable cartridge is configured to recirculate the second coating medium to the coating head via the second coating medium input port.

9. The system of claim 5, further comprising:
a flush fluid input port configured to receive a flush fluid from a flush fluid reservoir;
a third interchangeable cartridge configured to retain the flush fluid;
wherein the coating head is further configured to:
selectively receive one of the first coating medium, the second coating medium, or the flush fluid from a respective one of the first coating medium input port, the second coating medium input port, or the flush fluid input port, and
selectively receive one of the first coating medium, the second coating medium, or the flush fluid from a respective one of the first interchangeable cartridge, the second interchangeable cartridge, or the third interchangeable cartridge;
wherein the vacuum head is further configured to receive an excess amount of the first coating medium, the second coating medium, or the flush fluid from a respective one of the first coating reservoir, the second coating reservoir, or the flush fluid reservoir through the aperture; and
wherein the third interchangeable cartridge is configured to:
receive an excess amount of the flush fluid from the coating chamber, and
recirculate the flush fluid to the coating head.

10. The system of claim 9, wherein the third interchangeable cartridge is configured to receive an excess amount of the flush fluid from the vacuum head.

11. The system of claim 9, wherein the third interchangeable cartridge further comprises:
an overflow valve; and
a sensor configured to:
measure a level of the flush fluid in the third interchangeable cartridge, and
cause the overflow valve to open if the level of the flush fluid is greater than a maximum fill level.

12. The system of claim 5, wherein the third interchangeable cartridge is configured to recirculate the flush fluid to the coating head via the flush fluid input port.

13. A method for operating a coating component, the method comprising:
connecting a first interchangeable cartridge to a coating chamber drain valve;
receiving, at a coating head, a first coating medium from a first coating medium input port and from the first interchangeable cartridge;
coating a first substrate in a coating chamber by passing the first coating medium through an aperture in the coating head and into the coating chamber;
vacuuming, through a vacuum head, an excess amount of the first coating medium from the first substrate; and
receiving, at the first interchangeable cartridge and via the coating chamber drain valve, an excess amount of the first coating medium from the coating chamber.

14. The method of claim 13, further comprising:
receiving, at the first interchangeable cartridge and from the vacuum head, the vacuumed first coating medium.

15. The method of claim 13, further comprising:
measuring, with a sensor in the first interchangeable cartridge, a level of the first coating medium in the first interchangeable cartridge; and
if the level of the first coating medium is greater than a maximum fill level, causing an overflow valve in the first interchangeable cartridge to open.

16. The method of claim 13, wherein said receiving, at a coating head, a first coating medium from a first coating medium input port and from the first interchangeable cartridge further comprises:
receiving, at the coating head, the first coating medium from the first interchangeable cartridge via the first coating medium input port.

17. The method of claim 13, further comprising:
connecting a second interchangeable cartridge to the coating chamber drain valve;
receiving, at the coating head, a second coating medium from a second coating medium input port and from the second interchangeable cartridge;
coating a second substrate in a coating chamber by passing the second coating medium through the aperture in the coating head and into the coating chamber;
vacuuming, through the vacuum head, an excess amount of the second coating medium from the second substrate; and
receiving, at the second interchangeable cartridge and via the coating chamber drain valve, an excess amount of the second coating medium from the coating chamber.

18. The method of claim 17, further comprising:
receiving, at the second interchangeable cartridge and from the vacuum head, the vacuumed second coating medium.

19. The method of claim 17, further comprising:
measuring, with a sensor in the second interchangeable cartridge, a level of the second coating medium in the second interchangeable cartridge; and
if the level of the second coating medium is greater than a maximum fill level, causing an overflow valve in the second interchangeable cartridge to open.

20. The method of claim 17, wherein said receiving, at a coating head, a second coating medium from a second coating medium input port and from the second interchangeable cartridge further comprises:
receiving, at the coating head, the second coating medium from the second interchangeable cartridge via the second coating medium input port.

21. The method of claim 17, further comprising:
connecting a third interchangeable cartridge to the coating chamber drain valve;
receiving, at the coating head, a flush fluid from a flush fluid input port and from the third interchangeable cartridge;
passing the flush fluid through the aperture in the coating head and into the coating chamber;
vacuuming, through the vacuum head, an excess amount of the flush fluid from the coating chamber; and
receiving, at the interchangeable cartridge and via the coating chamber drain valve, an excess amount of the flush fluid from the coating chamber.

22. The method of claim 21, further comprising:
receiving, at the third interchangeable cartridge and from the vacuum head, the vacuumed flush fluid.

23. The method of claim 21, further comprising:
measuring, with a sensor in the third interchangeable cartridge, a level of the flush fluid in the third interchangeable cartridge; and
if the level of the flush fluid is greater than a maximum fill level, causing an overflow valve in the third interchangeable cartridge to open.

24. The method of claim 17, wherein said receiving, at a coating head, a flush fluid from a flush fluid input port and from the third interchangeable cartridge further comprises:
receiving, at the coating head, the flush fluid from the third interchangeable cartridge via the third coating medium input port.
